(19) United States
(12) Patent Application Publication
(10) Pub. No.: US 2010/0110541 A1
(43) Pub. Date: May 6, 2010

(54) MICROSCOPE SLIDE COVERSLIP AND USES THEREOF

(76) Inventor: Lee H. Angros, Bethany, OK (US)

Correspondence Address: DUNLAP CODDING, P.C., PO BOX 16370, OKLAHOMA CITY, OK, 73113, US

(21) Appl. No.: 12/604,066

(22) Filed: Oct. 22, 2009

Related U.S. Application Data
(63) Continuation-in-part of application No. 11/585,448, filed on Oct. 24, 2006, now abandoned.
(60) Provisional application No. 60/730,285, filed on Oct. 26, 2005.
(60) Provisional application No. 60/738,872, filed on Nov. 22, 2005.
(60) Provisional application No. 60/771,546, filed on Feb. 7, 2006.

(51) Int. Cl. G02B 21/34

(52) U.S. Cl. 359/397

(57) ABSTRACT

A slide microscope microscope slide coverslip constructed of a glass or plastic plate having an indicium thereon which can be used to uniquely or non-uniquely identify the microscope slide coverslip or the microscope slide to which the microscope slide coverslip is attached and/or provide information therefor. The indicium, such as a barcode, may be machine readable. The microscope microscope slide coverslip may have an adherent surface and a non-adherent surface, the adherent surface having a solvent activated dry adhesive film (adhesive coating) bonded thereto and having an indicium thereon for indicating the adherent side of the microscope slide coverslip. The dry adhesive film of the adherent surface is non-tacky (non-sticky) in its storage or preapplication condition. At use, the adhesive of the adherent side can be activated by a solvent.

### CROSS-REFERENCE TO RELATED APPLICATIONS

The present application is a Continuation-In-Part of U.S. Ser. No. 11/585,448, filed Oct. 24, 2006, now abandoned, which claims the benefit of priority under 35 U.S.C. 119(e) of U.S. Provisional Application Ser. No. 60/730,285, filed Oct. 26, 2005, and U.S. Provisional Application Ser. No. 60/738,872, filed Nov. 22, 2005, and U.S. Provisional Application Ser. No. 60/771,546, filed Feb. 7, 2006, the entirety of each of which is hereby expressly incorporated herein by reference.

### STATEMENT REGARDING FEDERALLY SPONSORED RESEARCH OR DEVELOPMENT

Not applicable.

### BACKGROUND

Microscope slide coverslips are typically used in the prior art to permanently cover a biological specimen affixed to a microscope slide. The microscope slide coverslip can be glass or plastic but is always transparent to enable the visualization of the biological specimen. The microscope slide coverslip is immobilized or mounted to the microscope slide with a mounting media. The mounting media is applied on top of the biological specimen and the microscope slide coverslip is placed onto the mounting media and any bubbles formed are pushed to the edges of the microscope slide coverslip to form a sealed microscope slide coverslip. Types of mounting media are well known in the art. These mounting media are collectively known as “mountants”. An early version mountant was made from the Canadian fir tree (Abies balsamea) and was known as Canadian balsam. This crude media turned yellow over time thus prohibiting the visualization of the biological specimen. More recent advances produced synthetic mountants which produced high quality, transparent, and non-yellowing cover slip mounting medias. A type of these high quality mountants is Cytoseal™ XYL which is commercially available from Richard-Allen Scientific®.

Also known in the art are microscope slide coverslips that feature a solvent activated adhesive on one side of the microscope slide coverslip. U.S. Pat. No. 6,759,011 discloses a solvent activated adhesive microscope slide coverslip that features a protuberance on the surface of the microscope slide coverslip opposite to the adhesive side to facilitate separation of one microscope slide coverslip from an adjacent microscope slide coverslip. This protuberance, having height of at least 0.0005 inch, is necessary to keep adjacent microscope slide coverslips from sticking together during packaging. The protuberance creates an air gap between adjacent microscope slide coverslips so the adhesive doesn't stick to another microscope slide coverslip.

Another commercially available proprietary adhesive microscope slide coverslip is manufactured by Richard-Allen Scientific®. The product name is E-Z Slips™. These adhesive microscope slide coverslips require the use of a special and proprietary adhesive activator solution known as E-Z Slip Activator™ and E-Z Slip Activator-A™.

However, there remains a need for a solvent activated dry film adhesive microscope slide coverslip that can use common laboratory solvents like xylene, toluene, acetone, and water, without the need for special proprietary activating solutions. There is a further need of a solvent activated dry film adhesive microscope slide coverslip that doesn't require a raised “protuberance” present on a surface of the microscope slide coverslip to separate each individual microscope slide coverslip to eliminate the microscope slide coverslips from sticking together. It is the object of the present invention to eliminate these cumbersome manufacturing problems and reduce the need for special activation solvents to gain the benefit from dry film adhesive microscope slide coverslips.

### SUMMARY OF THE INVENTION

The present invention comprises a microscope slide coverslip comprising a glass or plastic plate having an indicium thereon which can be used to uniquely or non-uniquely identify the microscope slide coverslip or the microscope slide to which the microscope slide coverslip is attached and/or provide information therefor. Preferably the indicium, such as a barcode, is machine readable. The present invention in another preferred embodiment comprises a microscope slide coverslip comprising a glass or plastic plate having an adherent surface and a non-adherent surface, the adherent surface having a solvent activated dry adhesive film (adhesive coating) bonded thereto and having an indicium thereon for indicating the adherent side of the microscope slide coverslip. The dry adhesive film of the adherent surface is non-tacky (non-sticky) in its storage or preapplication condition. At use, the adhesive of the adherent side can be activated by a solvent. Prior to use or sale, the microscope slide coverslips are stacked or adjacently placed next to another within a container such as a box. Since the dry adhesive film is dry and non-tacky, the microscope slide coverslips can remain in intimate contact with each other and not stick together and thus are easily separable during use. The dry adhesive film remains non-tacky, non-sticky under heat and cold storage (<0° C. to >100° C.).

### BRIEF DESCRIPTION OF THE DRAWINGS

FIG. 1 is a top plan view of a microscope slide coverslip constructed in accordance with the present invention.

FIG. 2 is a top plan view of an alternate embodiment of a microscope slide coverslip constructed in accordance with the present invention.

FIG. 3 is a top plan view of an alternate embodiment of a microscope slide coverslip constructed in accordance with the present invention.

FIG. 4 is a top plan view of an alternate embodiment of a microscope slide coverslip constructed in accordance with the present invention.

FIG. 5 is a top plan view of an alternate embodiment of a microscope slide coverslip constructed in accordance with the present invention.

FIG. 6 is a top plan view of an alternate embodiment of a microscope slide coverslip constructed in accordance with the present invention.

FIG. 7 is a top plan view of an alternate embodiment of a microscope slide coverslip constructed in accordance with the present invention.

FIG. 8 is a top plan view of an alternate embodiment of a microscope slide coverslip constructed in accordance with the present invention.

FIG. 9 is a top plan view of an alternate embodiment of a microscope slide coverslip constructed in accordance with the present invention.

FIG. 10 is a side cross sectional view of the microscope slide coverslip of FIG. 9 taken through line 9-9.

FIG. 11 is a top plan view of an alternate embodiment of a microscope slide coverslip constructed in accordance with the present invention.

FIG. 12 is a side cross sectional view of the microscope slide coverslip of FIG. 11 taken through line 11-11.

### DETAILED DESCRIPTION OF THE INVENTION

The present invention comprises a microscope slide coverslip comprising a glass or plastic plate having an indicium thereon which can be used to uniquely or non-uniquely identify the microscope slide coverslip or the microscope slide to which the microscope slide coverslip is attached. Preferably the indicium, such as a barcode, is machine readable.

The present invention in another preferred embodiment comprises a microscope slide coverslip comprising a glass or plastic plate having an adherent surface and a non-adherent surface, the adherent surface having a solvent activated dry adhesive film (adhesive coating) bonded thereto and having an indicium thereon for indicating the adherent side of the microscope slide coverslip. The dry adhesive film of the adherent surface is non-tacky (non-sticky) in its storage or preapplication condition. Prior to use or sale, the microscope slide coverslips are stacked or adjacently placed next to another within a container such as a box. Since the dry adhesive film is dry and non-tacky, the microscope slide coverslips can remain in intimate contact with each other and not stick together and thus are easily separable during use. The dry adhesive film remains non-tacky, non-sticky under heat and cold storage (<0° C. to >100° C.). The dry adhesive film may be applied to the entire adherent surface of the microscope slide coverslip or to only a portion of the adherent surface.

In a preferred embodiment, the storage of the microscope slide coverslips is in the temperature range of 0° C. to 70° C. and more preferably 20-30° C. In a preferred embodiment, the dry adhesive film of the adherent surface is an alkyd based (oil based) or aqueous based (water-based) acrylic polymer adhesive, including but not limited to methyl methacrylate, ethyl methacrylate, methyl methacrylate/ethyl methacrylate copolymer, butyl methacrylate, isobutyl methacrylate, acrylic ester copolymers, cyanoacrylates, ethyl acrylate, butyl acrylate, vinyl acrylates, alkyd bases acrylates, water bases acrylates, polyethylene, and epoxy resin polymers, and polyvinylacetate. A type of aqueous based adhesive is AquaPerm, commercially available from Thermo Electron Corp. The adhesive can be applied by any way known in the art of applying adhesives. Curing of the adhesive can be by air drying, including forced air and heated air, conducted heat, and ultra-violet curing.

The dry adhesive film becomes sticky when activated by a solvent (including, but not limited to xylene, toluene, acetone, other organic and inorganic solvents, or aqueous solvents including water, ethanol, methanol or other alcohols). Once in contact with the activating solvent, the dry adhesive film becomes soft and sticky and is then ready to be placed over a specimen on a microscope slide or another plate. After the activated (tacky) adhesive of the adherent surface is placed in contact with the specimen and the microscope slide, the adhesive layer on the microscope slide coverslip becomes hard and permanently seals the microscope slide coverslip to the microscope slide thereby enclosing the specimen between the microscope slide coverslip and microscope slide or other plate. In a preferred embodiment the time required for the adhesive to change from a tacky condition to a dry (hardened) state is less than one minute.

In an alternate embodiment the dry adhesive film is of an aqueous based resin that is activated by a aqueous solvent (e.g., water) so as to protect leaching of chemical dyes impregnated into the specimen by dye-incompatible solvents (e.g., certain organic solvents). The dry adhesive film on the adherent side of the microscope slide coverslip is preferably in the thickness range of less than 0.001 μm to greater than 100 μm. Preferably the thickness of the dry adhesive film is the range of 20-60 μm.

The dry adhesive film of the present invention when dried typically has a hard and brittle consistency or character. To activate the hard dry adhesive film of the adherent surface to a soft sticky condition, the solvent is put in contact with the dry adhesive film and preferably includes a step of applying pressure to the non-adherent (opposite, non-coated) side of the microscope slide coverslip so as to cause penetration of the solvent into the dry adhesive film to soften it to a sticky adherent phase. The pressure applied to the microscope slide coverslip is preferably between 0.01-10 psig. Preferably the pressure applied is in the range of 0.01-2 psig. This pressure not only facilitates penetration of the solvent into the dry adhesive film to activate it into a sticky adherent condition, but also pushes out any residual solvent away from the adhesive to leave a stoichimetric amount of solvent and adhesive to produce a consistent softening of the dry adhesive which is reproducible and consistent with each application. In an alternate embodiment, the dry adhesive film has a pattern when applied to the microscope slide coverslip to indicate the adherent side of the microscope slide coverslip.

Problems can occur if the user of the dry adhesive film microscope slide coverslip inadvertently loses track of which side of the microscope slide coverslip has the dry adhesive film thereon. For example, if the microscope slide coverslip is dropped on a counter or a floor, the orientation of the microscope slide coverslip may be altered, causing distress, loss of time, and expense for the technician. In such a case, the technician must determine which side of the microscope slide coverslip has the dry adhesive film. Since the dry adhesive film may be substantially optically clear, the technician may have difficulty determining which side of the microscope slide coverslip is which. If the proper orientation of the coating is not identified quickly, the technician could attempt to seal the wrong side of the microscope slide coverslip (i.e., the uncoated side) to the slide. In such a case, the microscope slide coverslip would not adhere to the slide and the microscope slide coverslip's dry adhesive film would be damaged and the microscope slide coverslip would have to be discarded and, further, the specimen on the slide may be damaged or lost.

To solve or avoid such problems, the present invention contemplates marking the microscope slide coverslip with an indicia in such a way as to make the orientation of the microscope slide coverslip (i.e., the location of the dry adhesive film on the microscope slide coverslip) unambiguously evident and apparent.

For example, in the embodiment of the present invention, the microscope slide coverslip has a visually identifiable or machine identifiable indicium thereon (on either the adherent or non-adherent side).

In one embodiment, these indicia can be marked by a laser (such as the laser used to cut the coated sheets of glass or plastic into the size of usable microscope slide coverslips). Initially, for example, the laser can etch the glass or plastic in a specific location on each microscope slide coverslip in an exact position before or after the final cutting of the microscope slide coverslip.

For example, the indicium (e.g., a dot, mark, code, barcode, label, or other feature indicated herein) could be etched in a corner of the non-adherent side of the microscope slide coverslip (such as the lower left corner) such that the dry adhesive film is on the side of the microscope slide coverslip opposite the side of the microscope slide coverslip having the indicium. If the technician loses track of the adherent side of the microscope slide coverslip, all the technician must then do is pick up the microscope slide coverslip, identify the indicium thereon, and properly orient the microscope slide coverslip with the adherent side facing downwardly, then place the microscope slide coverslip onto the microscope slide in the normal manner. These indicia can be dots, markings, symbols, letters, numbers, lines, shapes, or any insignias or other appropriate or feasible markings readable and/or identifiable by a machine or the human eye. The microscope slide coverslip may have a rounded, notched, or nicked, abraded, or colored edge or corner or a concave depression or a hole in the microscope slide coverslip to indicate the adherent side of the microscope slide coverslip. In another embodiment, be a rough or abraded surface of the dry adhesive film of the microscope slide coverslip may itself comprise the indicium.

For use with an automated microscope slide coverslipping instrument, the microscope slide coverslips are preferably marked with at least one machine-readable indicium for identification of the microscope slide coverslip and/or for distinguishing the adherent side of the microscope slide coverslip. If the orientation of the microscope slide coverslip was determined by the instrument to be incorrect, the technician would be notified to rearrange the microscope slide coverslip into the proper orientation to continue the automated microscope slide coverslipping process.

As noted above, each microscope slide coverslip preferably has at least one indicium and one adherent side having a solvent activated dry adhesive film thereon, may be present on either surface (or the edge) of the microscope slide coverslip. These indicia can be the same for each microscope slide coverslip in a batch or may be unique such that each microscope slide coverslip can be distinguished from every other microscope slide coverslip in the batch or may be universally unique. These unique identification indicia can be useful in the secondary identification of the patient's unique primary marking present elsewhere on the microscope slide (such as a unique barcode) that is present before testing and thus which would identify each unique slide for a particular patient.

In this embodiment, the indicium (e.g., a 2-D barcode) of the present invention, also referred to herein as an informational indicium, provides additional identification at the end of testing when the biological specimen is permanently preserved by the mounted unique microscope slide coverslip and the testing process is complete. The now completed and preserved microscope slide and microscope slide coverslip assembly could be scanned for the machine-readable indicium present on the microscope slide coverslip to further identify the patient's test data by saving the indicium information and linking it to the primary identification marking present before testing began (e.g., the barcode on the microscope slide). The laboratory's LIS [laboratory information system] could be programmed to accept the unique indicium by means of scanning the unique indicium thus linking the information represented in the microscope slide coverslip indicium electronically with the patient's primary identification information correlated with the microscope slide indicium.

A further value of the unique indicium present on the microscope slide coverslip, is its use in the event the primary identification markings of the slide are separated from the portion of the slide having the biological specimen (e.g., due to breakage or peeling of the primary identification markings from the microscope slide). In this case, the microscope slide coverslip indicium could then be used as an identifier for the slide. When the microscope slide coverslip is applied, the area of the slide surrounding the biological specimen is now thicker than the rest of the microscope slide (due to the two layers of slide and microscope slide coverslip) and the adhesive layer of the microscope slide coverslip positioned over the biological specimen which protects the specimen from breakage and total separation. The unique indicium present on the microscope slide coverslip would then serve to identify the biological specimen even if most of the microscope slide is missing, lost or broken way from the biological specimen.

As noted above, in another preferred embodiment of the invention, the microscope slide coverslip may have a non-unique or unique orientation indicium thereon even without dry adhesive film thereon for secondary identification of the patient's biological specimen. Thus a unique indicium can be applied to the microscope slide coverslip for orientation of the dry adhesive film (the “adherent” side) and/or for use in identification of the patient.

The indicium can be placed on the microscope slide coverslip by laser engraving, or frosting the indicium into the plastic or glass microscope slide coverslip. When the microscope slide coverslip has an adherent side, the indicium can be on the adherent side of the microscope slide coverslip or on the non-adherent side of the microscope slide coverslip. Preferably the indicium would be on the non-adherent (upper) side of the microscope slide coverslip, although alternatively the indicium can be on the adherent (lower) side of the microscope slide coverslip.

The microscope slide coverslips of the present invention can be of any size known in the art of microscope slide coverslips. Examples of preferred microscope slide coverslip thickness include, but are not limited to, the industry standard sizes of 1, 1.5, or 2 having thicknesses of 0.08 mm to about 0.35 mm and preferably 0.152 to 0.19 mm in thickness. Width and length examples include, but are not limited to, the industry standard sizes of 18×18 mm, 22×22 mm, 24×30 mm, 24×50 mm, 25×25 mm, 11×22 mm, 48×60 mm or circular microscope slide coverslips, such as those having standard diameters of, for example, 12 mm and 18 mm, may also be used. The microscope slide coverslip of the invention can be made of plastic or glass. The width, for example, may be in a range of 10 to 50 mm and the length, for example, in a range of 15 to 60 mm when the microscope slide coverslip is rectangular. When the microscope slide coverslip has a circular shape the diameter may be, for example, 10-25 mm.

In a preferred embodiment the microscope slide coverslip of the invention is constructed without a removable or non-removable polymeric backing (i.e., a protective coating or release layer) which covers the non-adherent side thereof.

In one embodiment non-unique indicia can be one or more letters placed at an asymmetric position on the microscope slide coverslip to distinguish the adherent and non-adherent sides of the microscope slide coverslip, for example, the indicium may be in the lower left hand corner of the non-adherent side in one particular batch of microscope slide coverslips. The user will know, for example, that when the indicium is in a lower left position, the adherent side is facing downwardly. These letters could stand, for example, for different types of adhesives present on the cover slip. For example, the letters “XL” could indicate the solvent needed to activate the adhesive is “xylene”. Another example are the letters “AQ”, which would indicate the need to use of an aqueous based solvent to activate the adhesive. Various dry adhesive film thickness as can be identified by letters or numbers such as “CY” for cytology specimens that need a dry adhesive film larger of, e.g., 50 μm on the microscope slide coverslip. These letters can be placed anywhere on the microscope slide coverslip in an asymmetric location to enable the technician to efficiently and properly orient the microscope slide coverslip for use.

Indicia used herein are defined as any marking produced by a laser or other glass or plastic etching or printing means or manufacturing means into or onto a surface of the microscope slide coverslip which are identifiable by the human eye or machine-readable instruments, and may include, but are not limited to, insignias, numbers, codes, barcodes (including 1-dimentional and 2-dimentional barcodes), symbols, other machine and eye readable patterns, letters, lines, or shapes or other marking as identified elsewhere herein.

Examples of barcodes contemplated for use in the present invention include but are not limited to symbologies having square, rectangular, circular, or irregular shapes and more specifically may include symbologies known as EAN-13, EAN-8, EAN-128, UPC-A, UPC-E, Code 11, Code 39, Code 93, Code 25, Code 128, Codabar, MSI, Jan 13, Jan 8, Plessey, Telepan, Interleaved 2 of 5, Discrete 2 of 5, 2-dimensional and RSS barcodes including Data Matrix, PDF417, Maxicode, Aztec Code, QR code, Micro PDF417, Samsung PDF417, Data Code, Code 49, 16K, RSS14, RSS limited, RSS Expanded, 2D Pharma Code, Glaxo Smith Kline, HIBC, IKS, IMH, Kurandt, Novartis Pharma, Pharma Code, and PZN. This size of the barcode indicia on the microscope slide coverslip may be in the range, for example, of 1 to 3 mm wide and 1 to 50 mm long (preferably 1-2 mm wide and 2-15 mm long) when having a rectangular shape and 3 to 6 mm (preferably 4-5 mm) in dimension when square.

Herein, where the indicium is defined as informational, the indicium preferably comprises one or more letters, numbers, symbols, characters, and/or patterns which represent information, data, or a message and wherein the informational indicium may or may not serve to identify the adherent side of the microscope slide coverslip. For example, the microscope slide coverslip could include an indicium for identifying the adherent side of the microscope slide coverslip, and an indicium for representing information. Alternatively the microscope slide coverslip could include an indicium for only indicating the adherent side or only an informational indicium.

In one embodiment the laser or other etching means produces the indicium by removing a portion of the microscope slide coverslip surface, therefore, the level of the indicium is lower than the original microscope slide coverslip surface. Indicia produced by a laser may appear engraved below the surface or have a frosted appearance. The lasered indicium may be colored to increase the visibility of the indicium by any manner known in the art of coloring or filling engraved surfaces. This filling or coloring can be of any color known in the art of utilizing coloring inks or coloring enhancing treatments.

As noted above, an indicium can be positioned on the microscope slide coverslip to locate the adherent side of the microscope slide coverslip for mounting biological specimens. These indicia can be located on either side or any edge of the microscope slide coverslip and are at least partially localized at these positions.

In a preferred embodiment, the indicium can be of a visible substance that is soluble in the solvent that activates the dry adhesive film. In this embodiment the solubilizable indicium, preferably a removable or disappearing ink, is present on the microscope slide coverslip in an asymmetric fashion (on either side or edge of the microscope slide coverslip, i.e., any surface). Before use, the indicium is dry, adhered, and visible on at least one area in an asymmetrical location on at least a portion of the microscope slide coverslip. The indicia may have color, or are otherwise visible to indicate their position on the microscope slide coverslip. The indicium can be seen by the technician and the adherent side is quickly identifiable by the technician since the indicium is present in an asymmetric location on the microscope slide coverslip. Once the microscope slide coverslip is mounted upon the microscope slide, the indicium in this embodiment is rendered invisible or colorless due to solubility of the indicium or chemical reactivity of the indicium causing the indicium to become invisible with the activating solvent that activates the dry adhesive film. The indicium becomes invisible with the solvent alone or can be wiped away from the microscope slide coverslip by wiping the solubilized indicium with the residual solvent present around the microscope slide coverslip or solvent which is added. The solubilized visible indicium can be wiped away leaving it less visible, completely invisible, at least partially removed, or completely removed from the microscope slide coverslip. It should be understood the indicia are visible marks placed on the microscope slide coverslips in an asymmetrical position as to distinguish the location of the adherent side (bottom side toward the microscope glass) of the cover slip, in relation to the non-adherent side (upper side, facing away from the microscope slide) thus enabling the microscope slide coverslip to be oriented in the correct position for mounting on the slide.

In alternative embodiments, the indicia may be opaque, transparent with or without color, or translucent with or without color. The indicium may have a thickness (i.e. an elevation above a surface) of less than or equal to 10⁻¹⁰ inch, 10⁻⁹ inch, 10⁻⁸ inch, 10⁻⁷ inch, 10⁻⁶ inch, 10⁻⁵ inch, or 10⁻⁴ inch, or may have a depth (below a surface) of 10⁻¹⁰ inch, 10⁻⁹ inch, 10⁻⁸ inch, 10⁻⁷ inch, 10⁻⁶ inch, 10⁻⁵ inch, or 10⁻⁴ inch. Preferably the thickness of the indicium when elevated is less than or equal to 0.0001 (10⁻⁴) inch (2.54×10⁻³ mm). The indicium may be an altered corner or edge of the microscope slide coverslip which is different from the other three corners or edges of the microscope slide coverslip which are identical to each other. For example the altered corner indicium may be a rounded corner or an angled (truncated) corner. The indicium may be a barcode, symbol, code, number or insignia, or any other indicium described herein, and may be etched (e.g., by a laser) or printed onto the microscope slide coverslip or produced by other means known in the art. The indicium may be machine readable, and may be unique for each microscope slide coverslip or batch of microscope slide coverslips. The indicia of the microscope slide coverslips in a particular batch may be in a successive series for enabling the unique identification of the slide upon which the microscope slide coverslip is placed. The indicium may be permanent or removable (for example by the solvent used to activate the dry adhesive film). The indicium may be an asymmetrical alteration of the structure of the microscope slide coverslip, e.g., with a notch, nick, hole, incision, or laterally-extending edge protuberance, or other physical alteration.

The indicium may be for example at least one dot, circle, mark, code, barcode (including 1-dimensional and 2-dimensional barcodes as described elsewhere herein), label, character, shape, symbol, letter, number, line, insignia, physical alteration of the microscope slide coverslip, pattern, color, holographic image, or iridescent image, any of which may be machine readable, and any of which may be raised above or etched below one or both surfaces of the microscope slide coverslip. The indicium may be printed with an ink and preferably has a thickness of less than 10⁻⁴ inch, or less than 10⁻⁵ inch (or less as indicated above). When printed on the microscope slide coverslip, the ink may be applied by screen printing, pad printing, lithography, laser jet, ink jet, offset printing, roll printing, barrel printing, or stamping, or any other technique known to those of ordinary skill in the art. Curing of the adhesive can be by air drying, including forced air and heated air, conducted heat, and ultra-violet curing. Preferably the ink comprises a pigment (opaque, transparent, or translucent) with or without a silane linking component or curing catalyst. The ink can be of any known in the art for producing a visual contrast to the glass or plastic plate and that has a thickness of less than 0.0001 inch after cure. Preferably the thickness of the ink is less than 0.00001 inches. Ink types like epoxy and acrylics are known and can be used for the present invention.

The indicium can be a delineated or structural alteration to the microscope slide coverslip, including a removed portion of a corner, such as a rounded corner, or a truncated corner. The removed portion can be a line, nick, notch, and/or cut in the microscope slide coverslip. The structural alteration is a removed or asymmetrical alteration to the structure of an otherwise standard square, rectangular, or circular symmetrical commercially available microscope slide coverslip. In those embodiments of the present microscope slide coverslip wherein the indicium is a structural deletion from the plate (e.g., a rounded corner, notched corner, hole, cut corner), the automated microscope slide coverslipping instrument may have a complementary storage hopper or container to hold and store the microscope slide coverslips. This storage hopper or container preferably would have a component, e.g., a complementarily shaped surface, for engaging the indicium (e.g., angled) or a rod for engaging an indicium hole.

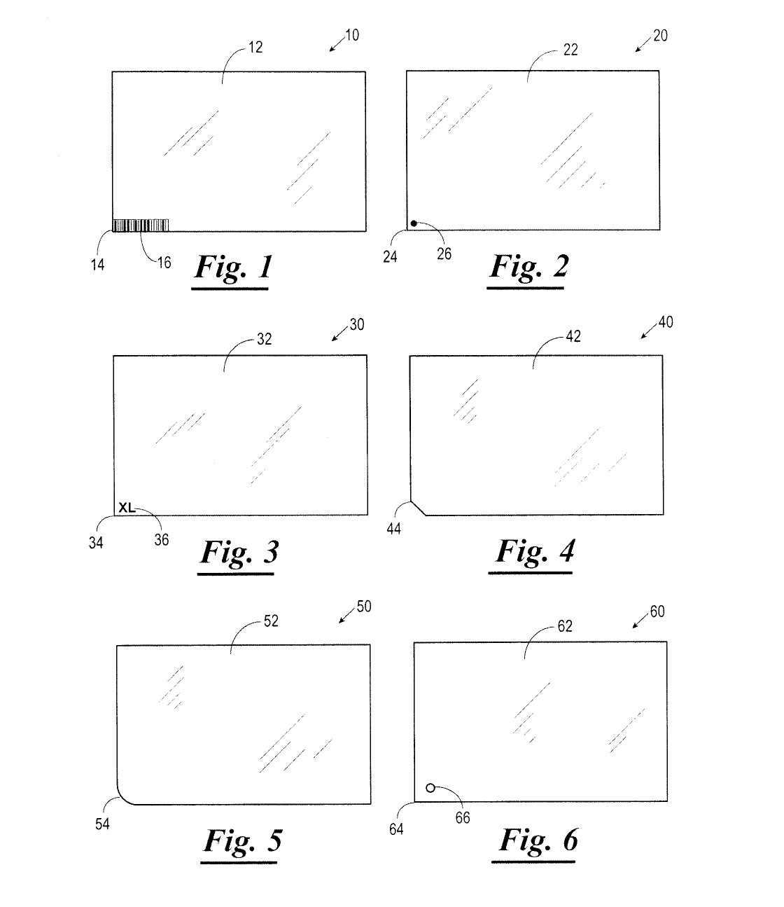

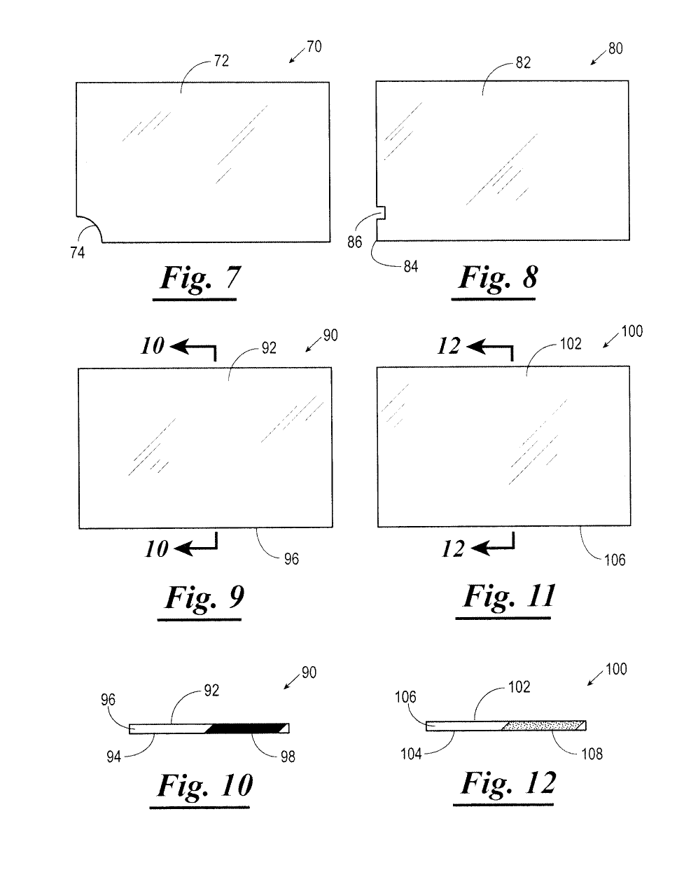

Turning now to the figures, shown therein are embodiments of the microscope slide coverslips of the present invention showing various indicia which may be used. Shown in FIG. 1 is a microscope slide coverslip 10 constructed of a glass or plastic plate as described elsewhere herein. Microscope slide coverslip 10 has an upper surface 12 and a corner 14. The microscope slide coverslip 10 has a barcode indicium 16 in the corner 14. The barcode 16 may be any barcode as contemplated or described herein. Shown in FIG. 2 is another microscope slide coverslip embodiment comprising microscope slide coverslip 20 with upper surface 22, corner 24 and indicium 26. Indicium 26 may comprise a printed dot, an etched dot, or a depression and my be colored, or have any shape other than a dot or circle. Shown in FIG. 3 is a microscope slide coverslip 30 having an upper surface 32, a corner 34 and an indicium 36 which in this case is a alphabetic and/or numeric symbol, such as letters. Shown in FIG. 4 is a microscope slide coverslip 40 having and upper surface 42. In this embodiment of the invention, the microscope slide coverslip 40 has an indicium 44 which comprises a corner truncated to have an angular edge which is distinguishable from all other corners of the microscope slide coverslip 40. FIG. 5 is a microscope slide coverslip 50 having an upper surface 52 and an indicium 54 which is a convex curved corner. FIG. 6 is a microscope slide coverslip 60 having an upper surface 62, a corner 64, and an indicium 66 which comprises a hole or depression in the microscope slide coverslip 60. FIG. 7 is a microscope slide coverslip 70 having an upper surface 72 and an indicium 74 which comprises an inwardly curved (concave) notch in a corner of the microscope slide coverslip 70. FIG. 8 is a microscope slide coverslip 80 having an upper surface 82, a corner 84 and an indicium 86 which comprises a notch in an edge in the microscope slide coverslip 80 near the corner 84. FIGS. 9 and 10 show a microscope slide coverslip 90 having an upper surface 92, a lower surface 94, and edge 96 and an indicium 98. The indicium 98 is a color (such as, but not limited to, white, black, red, blue, green, orange, or yellow) applied to at least a portion of edge 96. FIGS. 11 and 12 show a microscope slide coverslip 100 having an upper surface 102, a lower surface 104, an edge 106 and an indicium 108 which comprises an abraded or frosted surface of the edge 106.

In the embodiment of FIGS. 9 and 10 the indicium 98 may be color coded so the color of the microscope slide coverslip 90 indicates whether the microscope slide coverslip 90 is to be activated by an organic solvent versus an aqueous solvent. Further, the color of the indicium 98 may be such that the intensity of the color is accentuated when a plurality of the microscope slide coverslips 90 are stacked together.

The dry adhesive film microscope slide coverslips of the present invention can be used manually or in an automated microscope slide coverslipping instrument. Automated microscope slide coverslipping instruments known in the art can be easily modified by replacing the mountant normally dispensed onto the microscope slide with the solvent that activates the dry adhesive film, thus eliminating the inconsistencies of the mountant being dispensed onto the microscope slide prior to the placement of a prior art microscope slide coverslip. For example, there are several known inconsistencies when dispensing mountants in an automated microscope slide coverslipper. One major inconsistency is maintaining the viscosity of the mountant, which changes from day to day due to evaporation of the solvent over time wherein the mountant becomes more viscous. This increase in viscosity of the mountant causes the dispensing ports of automated microscope slide coverslippers to become clogged and subsequently inconsistent in the dispensing of the mountant onto the microscope slide. If the solvent is dispensed only onto the microscope slide or onto the adherent side of the microscope slide coverslip of the present invention, there is not a viscosity problem because any excessive solvent will evaporate and each activated adhesive microscope slide coverslip will have the same consistent layer of adhesive to cover and seal the biological specimen on the microscope slide.

In another embodiment, the invention is a self-adhering microscope slide coverslip constructed from an acrylic material which is solubilizable with organic solvents such as xylene. The acrylic material may be, for example, ethyl methacrylate or methyl methacrylate. In such an embodiment, the microscope slide coverslip is constructed without glass or without an additional plastic layer. The self-adhering microscope slide coverslip is exposed to an activating solvent and is then applied to a microscope and mounted therein.

In this embodiment the microscope slide coverslip can be manufactured entirely from one or more of a polymer such as, but not limited to, ethyl methacrylate/methyl methacrylate copolymer, ethyl methacrylate, methyl methacrylate, butyl methacrylate, isobutyl methacrylate, acrylic ester copolymers, cyanoacrylates, ethyl acrylate, butyl acrylate, ethyl acetate, vinyl acrylates, aklyd bases acrylates, water bases acrylates, polyethylene, and epoxy resin polymers. Types of aqueous based polymers include AquaPerm™, commercially available from Thermo Electron Corp, and polyvinylacetate. This embodiment would feature a microscope slide coverslip having the chemical make up of polymers including up to 100% of the material of the microscope slide coverslip which, in use, becomes soft and sticky on the lower side contracting the solvent. Once in contact with the solvent, the lower portion of the polymer microscope slide coverslip becomes soft and tacky and seals the biological specimen and dries to a hard polymer film over the biological specimen. In the mechanism of activation, the solvent softens the hard polymer microscope slide coverslip lower surface and softens the microscope slide coverslip before the solvent evaporates. Once the solvent evaporates the lower softened slide of the microscope slide coverslip becomes hard again. This embodiment doesn't rely on the adhesive having a substrate (glass or plastic), but rather the entire cover slip is a solublizable microscope slide coverslip made from up to 100% soluble polymers. Either side of the microscope slide coverslip can be utilized to seal the biological specimen because the entire microscope slide coverslip is manufactured from the soluble polymer. In this embodiment only one side of the polymer microscope slide coverslip is softened by the solvent, while the top side remains hard. The softened side, once it re-hardens, remains transparent so the now sealed biological specimen can be viewed under a microscope.

In another embodiment, the present invention is directed to a microscope slide and microscope slide coverslip assembly comprising a microscope slide having a barcode thereon and having a microscope slide coverslip of the present invention adhered thereto.

While the invention has been described herein in connection with certain embodiments so that aspects thereof may be more fully understood and appreciated, it is not intended that the invention be limited to these particular embodiments. On the contrary, it is intended that all alternatives, modifications and equivalents are included within the scope of the invention as defined by the appended claims. Thus the examples described herein, which include preferred embodiments, will serve to illustrate the practice of this invention, it being understood that the particulars shown are by way of example and for purposes of illustrative discussion of preferred embodiments of the present invention only and are presented in the cause of providing what is believed to be the most useful and readily understood description of procedures as well as of the principles and conceptual aspects of the invention. Changes may be made in the formulation of the various embodiments described herein or in the steps or the sequence of steps of the methods described herein without departing from the spirit and scope of the invention as described and claimed herein.

What is claimed is:

1. A microscope slide coverslip, comprising:
a glass or plastic plate having a first surface, a second surface, and an outer peripheral edge, the first surface having an adhesive coating disposed thereon forming an adherent side and the second surface absent an adhesive coating forming a non-adherent side, and wherein the adherent side has a dry, non-tacky condition until activated by a solvent to form a tacky condition, the glass or plastic plate further comprising an indicium on or in the first surface, second surface, or outer peripheral edge for distinguishing the adherent side from the non-adherent side of the glass or plastic plate, or for providing identification of the microscope slide coverslip and wherein the indicium comprises a barcode on or in the glass or plastic plate and wherein the glass or plastic plate is absent a protective coating on the non-adherent side thereof.

2. The microscope slide coverslip of claim 1 wherein the indicium has a thickness of 0.0001 inch or less when the indicium is elevated above a surface of the microscope slide coverslip.

3. The microscope slide coverslip of claim 1 wherein the indicium is positioned on the non-adherent side of the glass or plastic plate.

4. The microscope slide coverslip of claim 1 wherein the indicium is positioned on the adherent side of the glass or plastic plate.

5. The microscope slide coverslip of claim 1 wherein the indicium is positioned on the outer peripheral edge of the glass or plastic plate.

6. The microscope slide coverslip of claim 1 wherein the indicium is machine readable.

7. The microscope slide coverslip of claim 1 wherein the indicium is unique.

8. The microscope slide coverslip of claim 1 wherein the indicium is positioned asymmetrically on the glass or plastic plate.

9. The microscope slide coverslip of claim 1 wherein the indicium becomes colorless, invisible or removable upon exposure to an adhesive activating solvent.

10. The microscope slide coverslip of claim 1 wherein the barcode is one-dimentional or two-dimentional.

11. The microscope slide coverslip of claim 1 wherein the barcode has a square, rectangular, circular, or irregular shape.

12. The microscope slide coverslip of claim 1 wherein the barcode comprises a symbology known as EAN-13, EAN-8, EAN-128, UPC-A, UPC-E, Code 11, Code 39, Code 93, Code 25, Code 128, Codabar, MSI, Jan 13, Jan 8, Plessey, Telepan, Interleaved 2 of 5, Discrete 2 of 5, or 2-dimensional and RSS barcodes such as Data Matrix, PDF417, Maxicode, Aztec Code, QR code, Micro PDF417, Samsung PDF417, Data Code, Code 49, 16K, RSS14, RSS limited, RSS Expanded, 2D Pharma Code, Glaxo Smith Kline, HIBC, IKS, IMH, Kurandt, Novartis Pharma, Pharma Code, and PZN.

13. The microscope slide coverslip of claim 1 wherein the size of the barcode is in the range of 1 to 3 mm wide and 1 to 50 mm long when having a rectangular shape and is in the range of 3 to 6 mm per side dimension when square.

14. The microscope slide coverslip of claim 1 having a width in the range of 10 to 50 mm and a length in the range of 15 to 60 mm when the microscope slide coverslip has a rectangular shape or having a diameter in the range of 10 to 25 mm when the microscope slide coverslip has a circular shape.

15. The microscope slide coverslip of claim 1 having a thickness in a range of 0.08 mm to 0.35 mm.
